(19) United States
(12) Patent Application Publication
(10) Pub. No.: US 2008/0035766 A1
(43) Pub. Date: Feb. 14, 2008

(54) Tree sprinkler

(76) Inventor: Roy Bradley Belz, Mineral Wells, TX (US)

Correspondence Address: JAMES RAY & ASSOCIATES, 2640 PITCAIRN ROAD, MONROEVILLE, PA, 15146, US

(21) Appl. No.: 11/890,219

(22) Filed: Aug. 3, 2007

Related U.S. Application Data
(60) Provisional application No. 60/821,837, filed on Aug. 9, 2006.

(51) Int. Cl. B05B 3/00

(52) U.S. Cl. 239/726

(57) ABSTRACT

A water sprinkling apparatus primarily for trees includes a branched piping manifold in a substantially horizontal plane and forming a predetermined pattern, such as a U, an H, or a Y. At least three pipe fittings are disposed along the branched piping manifold to provide attachment of at least two sprinkler heads removably screwed into the pipe fittings. A common garden hose connection also attaches to the manifold and provides water supply to all the attached spray nozzles, which preferably offer adjustable spray patterns and distances.

### CROSS REFERENCE TO RELATED APPLICATION

This patent application is related to and claims priority from U.S. Provisional Patent Application Ser. No. 60/821,837 filed Aug. 4, 2006.

### FIELD OF THE INVENTION

The present invention relates, in general, to devices for watering trees and, more particularly, this invention relates to a sprinkler apparatus for distributing water over most of the ground area under a tree.

### BACKGROUND OF THE INVENTION

Prior to the conception and development of the present invention, there have been many commercially available devices for sprinkling water over grass-covered lawns. During dry hot spells, it may be more important to irrigate some trees as opposed to the grass. Dried out grass often makes a comeback, or at least can be replanted. On the other hand, it could take decades to replace a desirable shade tree. During drought periods, water conservation is often mandated; hence, it would be prudent to not waste water on the grass. Common lawn sprinklers generally are designed to spread water somewhat evenly over a wide, often rectangular or circular area. For watering a tree, these patterns may be undesirable in that too much water might be hitting the trunk area where excessive moisture could lead to fungus or insect infestation.

Sprinklers designed specifically for trees have been disclosed in the prior art. Taggart in U.S. Pat. No. 1,758,767 discloses a circular sprinkler in two halves such that one half pivots up to permit placement around the tree, which is a multi-step process. Orifices in the top of the semi-circular pipe sections spray water, supplied from a connected hose, outward and upward at different angles that vary along the pipe sections. Somewhat similar is the tree watering yoke taught by McSheehy in U.S. Pat. No. 5,285,968. McSheehy's device has a somewhat flexible annular body that does not form a full circle, and may need to be spread apart to fit around some trees. It also directs water outward and upward from orifices, but McSheehy is very specific and adamant that the water from his device lands at and beyond the drip line of the tree with virtually no watering of the ground under the tree. Besides this serious limitation on the McSheehy device, both of the aforementioned tree watering devices require a significant effort to put in place around a tree, and have the additional drawback of little ability to adjust the spray pattern and distance other than by water pressure back at the source valve. In addition, the significant upward spraying of fine streams of water allows for significant evaporation before the water hits the ground.

### SUMMARY OF THE INVENTION

The present invention provides a water sprinkling apparatus, primarily for trees, and includes a branched piping manifold in a substantially horizontal plane and forming a predetermined pattern, such as a U, an H, or a Y. At least three pipe fittings are disposed along the branched piping manifold to provide attachment of at least two sprinkler heads removably screwed into the pipe fittings. A common garden hose connection also attaches to the manifold and provides water supply to all the attached spray nozzles, which preferably offer adjustable spray patterns and distances.

### OBJECTS OF THE INVENTION

It is, therefore, one of the primary objects of the present invention to provide proper water irrigation to a tree without wasted water and effort.

Another object of the present invention is to provide a tree sprinkler system that is easy to set up and move.

Still another object of the present invention is to provide a tree sprinkler that can also serve as a lawn sprinkler.

Yet another object of the present invention is to provide a watering apparatus with adjustable spray patterns and distance.

In addition to the various objects and advantages of the present invention described with some degree of specificity above, it should be obvious that additional objects and advantages of the present invention will become more readily apparent to those persons who are skilled in the relevant art from the following more detailed description of the invention, particularly, when such description is taken in conjunction with the attached drawing figures and with the appended claims.

### BRIEF DESCRIPTION OF THE DRAWINGS

FIG. 1 is perspective view of a U-shaped tree sprinkler positioned around a tree.

FIG. 2 is perspective view of an H-shaped tree sprinkler positioned around a tree.

FIG. 3 is perspective view of a Y-shaped tree sprinkler positioned around a tree.

### DESCRIPTION OF A PRESENTLY PREFERRED AND VARIOUS ALTERNATIVE EMBODIMENTS OF THE INVENTION

Prior to proceeding to the more detailed description of the present invention it should be noted that, for the sake of clarity and understanding, identical components which have identical functions have been identified with identical reference numerals throughout the several views illustrated in the drawing figures.

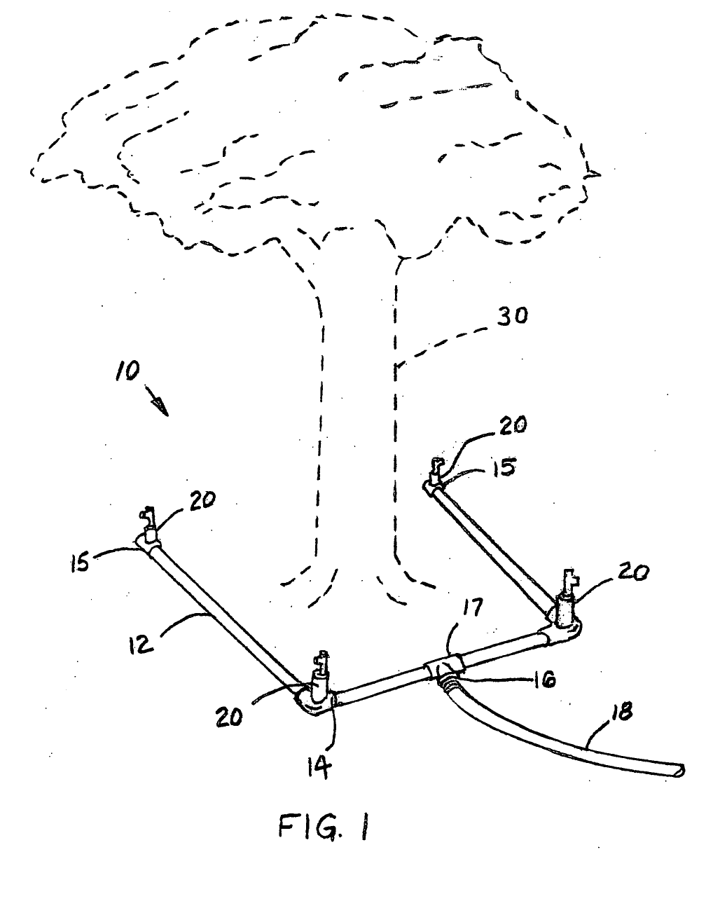

Referring initially to FIG. 1, the preferred embodiment of the present invention 10 is shown with its relationship to a tree 30 and a standard garden hose 18. The piping manifold 12 is in a U shape with a wide open end to easily fit around nearly all trees. At the two ends are elbows 15 adaptable to accepting a sprinkler head 20. At the corners are elbow-tee combinations 14 that also can accommodate vertical sprinkler heads 20. Along any segment of the manifold is a tee 17 with the branch run accommodating a female threaded garden hose connection. The sprinkler heads 20 may be either spray or rotary non-pop-up type. The preferred would be an a 270 degree arc nozzle on a sprinkler head body (riser), such as those made by Hunter and sold at www.evergreensprinklers.com; aimed so that water is not hitting the tree trunk from 4 different directions, but a wide area is still covered.

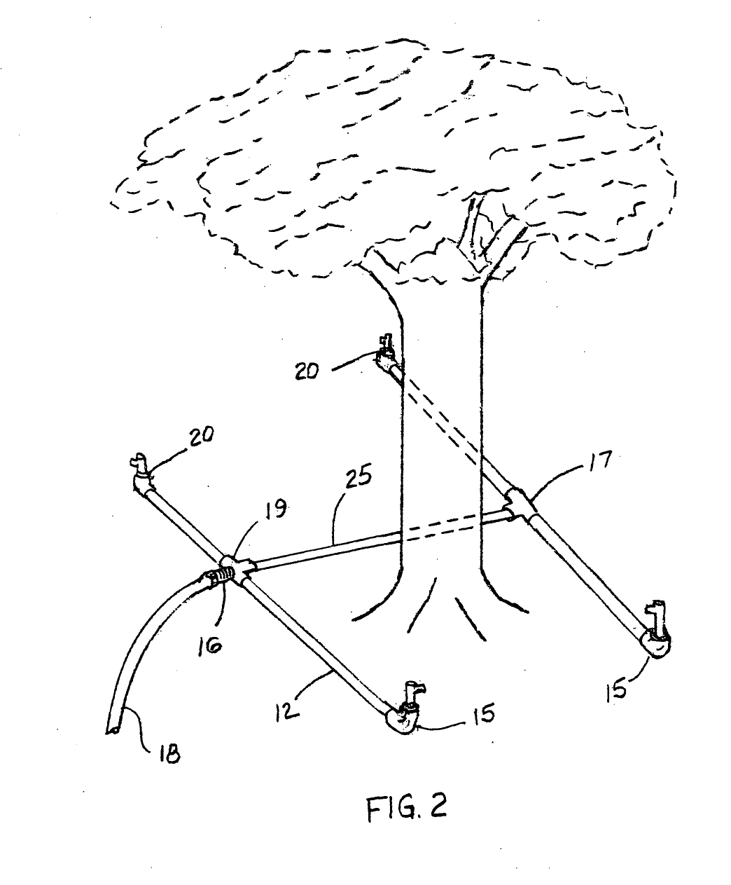

FIG. 2 illustrates a similar tree sprinkler, but in an H configuration. The garden hose 18 could connect anywhere along the pipe manifold 12, but preferred is a 4-way cross connection 19 with one branch having a female threaded garden hose connection 16. Also branching off of cross 19 is cross-connecting pipe 25 connects the two parallel members of the manifold 12 ending at a tee 17. The four ends of the manifold 12 terminate with elbows 15 to which sprinkler heads 20 are connected. The preferred would be an adjustable arc spray type, but others could be used as well.

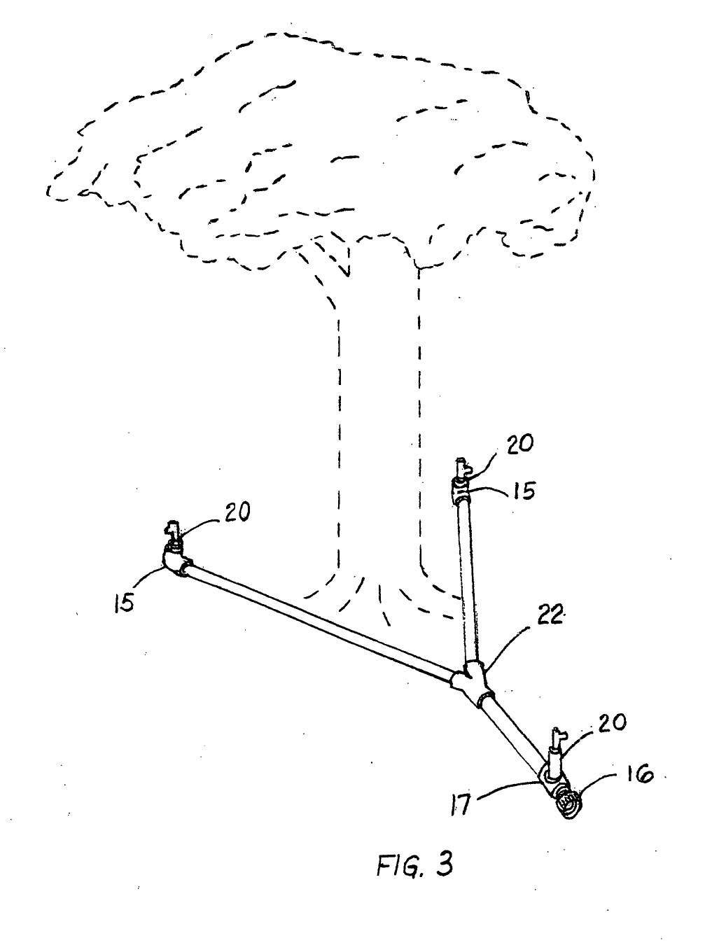

FIG. 3 shows another variation of the utilizing a Y configuration. The three legs of the manifold join at a Y fitting 22. Two legs end in an elbow 15 to which sprinkler heads 20 connect and extend vertically. The other branch connects to tee 17 with a sprinkler head 20 installed in the branch run and a female threaded garden hose connection 16 in the other through run. The preferred sprinkler head would be a fixed riser with an adjustable arc spray nozzle, but others could be used as well.

While a presently preferred and various alternative embodiments of the present invention have been described in sufficient detail above to enable a person skilled in the relevant art to make and use the same, it should be obvious that various other adaptations and modifications can be envisioned by those persons skilled in such art without departing from either the spirit of the invention or the scope of the appended claims.

I claim:

1. A water sprinkling apparatus comprising:
a) a branched piping manifold in a substantially horizontal plane, said branched piping manifold forming a predetermined pattern;
b) at least three pipe fittings disposed along said branched piping manifold in liquid communication with interior of said branched piping manifold, said fittings having threaded branches substantially perpendicular to said branched piping manifold;
c) at least two sprinkler heads removably connected to said pipe fittings disposed along said branched piping manifold; and
d) a common garden hose connection attached to one of said at least three pipe fittings.

2. The water sprinkling apparatus, according to claim 1, wherein said predetermined pattern is U-shaped.

3. The water sprinkling apparatus, according to claim 1, wherein said predetermined pattern is H-shaped.

4. The water sprinkling apparatus, according to claim 1, wherein said predetermined pattern is Y-shaped.

5. The water sprinkling apparatus, according to claim 1, wherein said sprinkler heads are one of spray and rotary types.

6. The water sprinkling apparatus, according to claim 1, wherein said sprinkler head is an adjustable arc type spray nozzle on a riser.

7. The water sprinkling apparatus, according to claim 1, wherein said sprinkler head is a riser with a fixed 270-degree arc spray nozzle with no spray directed toward the tree trunk.
